(19) United States
(12) Patent Application Publication
(10) Pub. No.: US 2023/0286004 A1
(43) Pub. Date: Sep. 14, 2023

(54) Retractable Fence Assembly

(71) Applicant: Marcela Bonilla, Upland, CA (US)

(72) Inventor: Marcela Bonilla, Upland, CA (US)

(21) Appl. No.: 17/690,184

(22) Filed: Mar. 9, 2022

(51) Int. Cl. B05B 12/32; E04H 17/00

(52) U.S. Cl. CPC B05B 12/32; E04H 17/00

(57) ABSTRACT

A retractable fence assembly for protecting a vehicle from being sprayed by a sprinkler system includes a housing that is buried beneath ground to concealed the housing from view and the housing is positioned adjacent to a parking space of a vehicle. A pair of poles is each movably disposed in the housing and each of the poles comprising a plurality of telescopic sections such that each of the poles has a telescopically adjustable height. A pair of actuators is each positioned within the housing and each of the actuators is in mechanical communication with a respective one of the poles. Each of the actuators urges the respective pole into an elongated condition or a retracted position. A barrier is coupled between the pair of poles to block water sprayed from a sprinkler system from contacting a vehicle parked in the vehicle parking spot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fence devices and more particularly pertains to a new fence device for protecting a vehicle from being sprayed by a sprinkler system. The device includes a housing that is buried and the housing is positioned adjacent to a parking space of a vehicle. The device includes a pair of actuators that is positioned in the housing. The device includes a pair of telescopic poles and a barrier extending between said telescopic poles. Each of the telescopic poles is coupled to a respective one of the actuators and each of the telescopic poles is either extended outwardly from the housing or retracted into the housing. The barrier protects the vehicle from being sprayed by the sprinkler system.

### (2) Description of Related Art Including Information Disclosed Under 37 CFR 1.97 and 1.98

The prior art relates to fence devices including a sprinkler barrier that includes a spike and a pair of panels each angling away from the spike for blocking water from a sprinkler. The prior art discloses a baseball barrier that includes a barrier that is retracted beneath ground and a motion sensor that extends the barrier to protect a baseball pitcher from a line drive baseball. The prior art discloses a barrier device that includes a screen with a hole extending through the screen such that the screen can be positioned around a vehicle tire and a drip pan attached to the screen. The prior art discloses an automatic water barrier device that automatically deployed a water barrier when a predetermined water level is detected. The prior art discloses a paint shield device that is attached to an eave of a building to protect a roof of the building when exterior walls are being painted.

### BRIEF SUMMARY OF THE INVENTION

An embodiment of the disclosure meets the needs presented above by generally comprising a housing that is buried beneath ground to conceal the housing from view and the housing is positioned adjacent to a parking space of a vehicle. A pair of poles is each movably disposed in the housing and each of the poles comprising a plurality of telescopic sections such that each of the poles has a telescopically adjustable height. A pair of actuators is each positioned within the housing and each of the actuators is in mechanical communication with a respective one of the poles. Each of the actuators urges the respective pole into an elongated condition or a retracted position. A barrier is coupled between the pair of poles to block water sprayed from a sprinkler system from contacting a vehicle parked in the vehicle parking spot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side in-use view of a retractable fence assembly according to an embodiment of the disclosure.

FIG. 2 is a perspective view of an embodiment of the disclosure showing a barrier being deployed.

FIG. 3 is a perspective view of an embodiment of the disclosure showing a barrier being retracted.

FIG. 4 is a front view of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

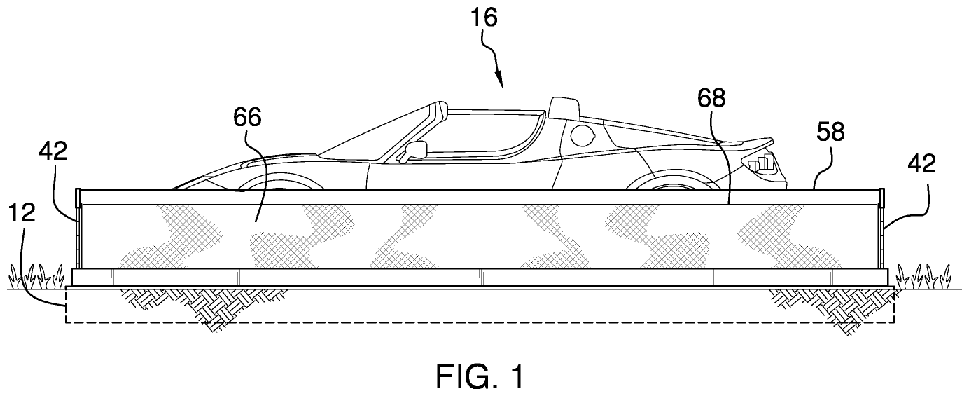

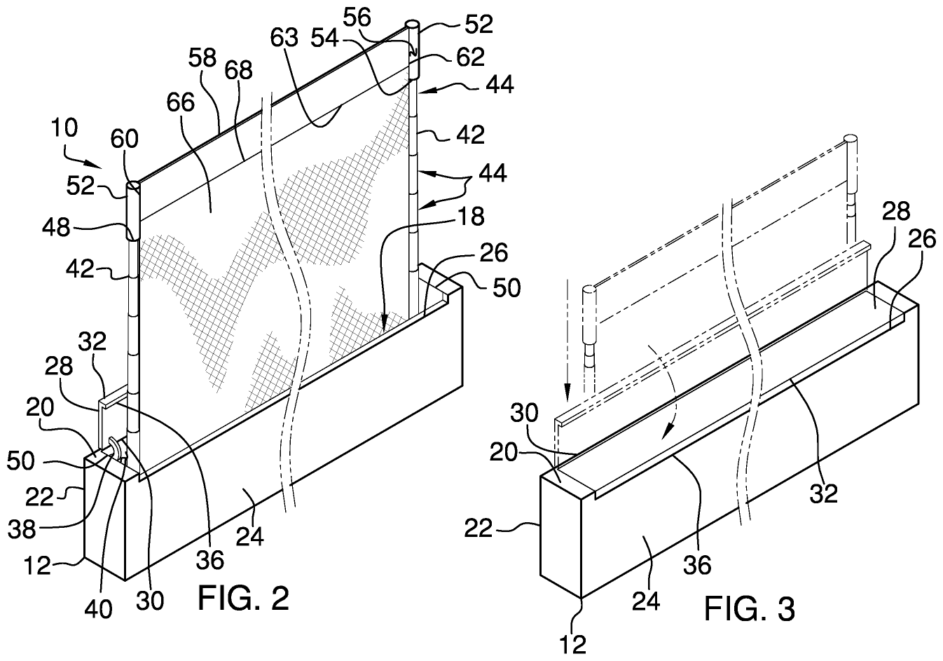

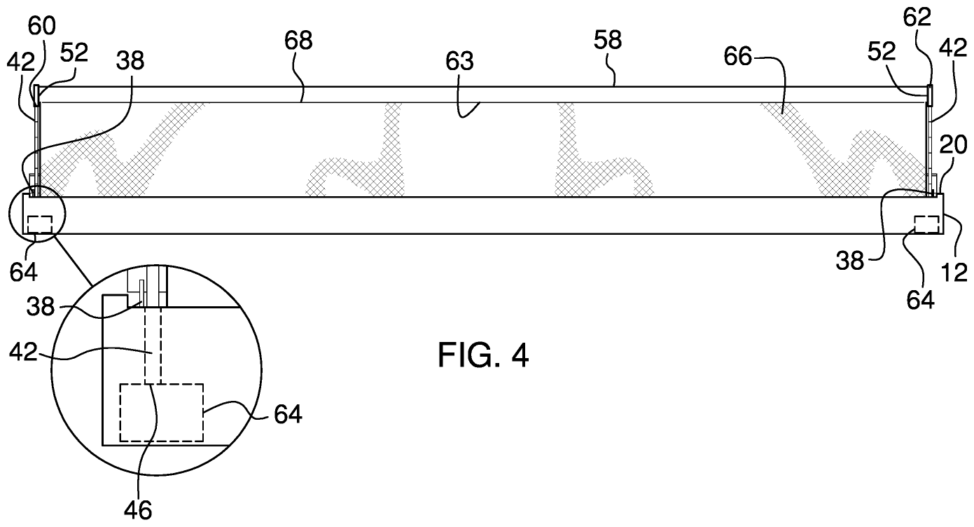

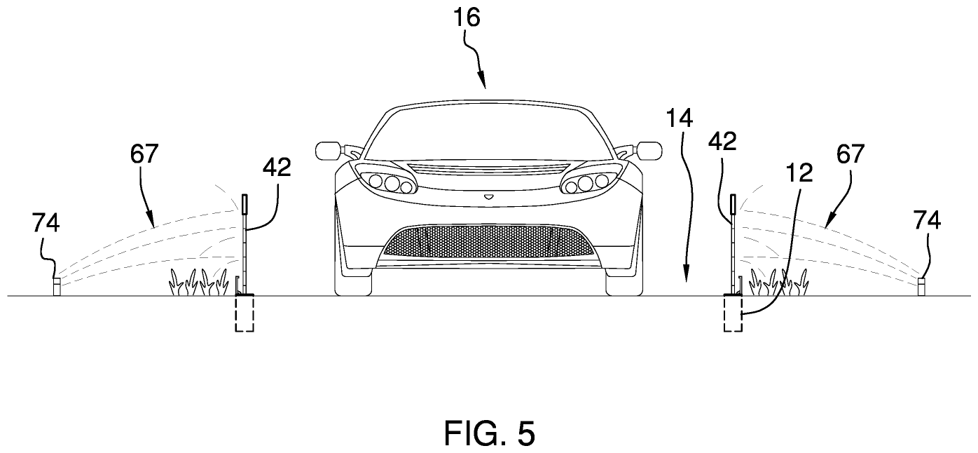

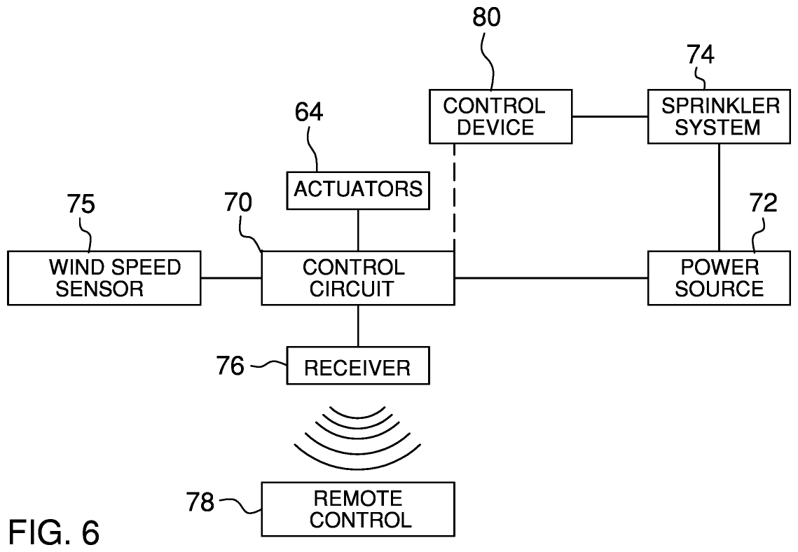

With reference now to the drawings, and in particular to FIGS. 1 through 6 thereof, a new fence device embodying the principles and concepts of an embodiment of the disclosure and generally designated by the reference numeral 10 will be described.

As best illustrated in FIGS. 1 through 6, the retractable fence assembly 10 generally comprises a housing 12 that is buried beneath ground such that the housing 12 is concealed from view. The housing 12 is positioned adjacent to a parking space 14 of a vehicle 16 and the housing 12 has an opening 18 extending into an interior of the housing 12. The housing 12 has a top wall 20, a back wall 22 and a front wall 24, and the opening 18 extends through the top wall 20. The opening 18 extends along a substantial length of the top wall 20. The front wall 24 has a recess 26 extending downwardly into the front wall 24 and the recess 26 is aligned with an intersection between the top wall 20 and the front wall 24. The recess 26 extends along a full length of the opening 18 and the top wall 20 is exposed with respect to the ground.

A lid 28 is provided which is hingedly coupled to the housing 12 for opening 18 and closing the opening 18 in the housing 12. The lid 28 has a rear edge 30, a front edge 32 and a bottom surface 34 extending between the front edge 32 and the rear edge 30. The lid 28 has a lip 36 extending downwardly from the bottom surface 34, and the lip 36 is aligned with and is coextensive with the front edge 32. Furthermore, the lip 36 is positioned in the recess 26 in the front wall 24 of the housing 12 when the lid 28 is in a closed position. A pair of hinges 38 is each coupled between the bottom surface 34 of the lid 28 and an interior surface 40 of the back wall 22. Each of the hinges 38 may be spring loaded such that each of the hinges 38 biases the lid 28 into a closed position.

A pair of poles 42 is provided and each of the poles 42 is movably disposed in the housing 12. Each of the poles 42 comprises a plurality of telescopic sections 44 such that each of the poles 42 has a telescopically adjustable height. Each of the poles 42 has a lower end 46 and an upper end 48, and the lower end 46 of each of the poles 42 is positioned within the housing 12. Additionally, each of the poles 42 is positioned adjacent to opposite ends 50 of the opening 18 in the top wall 20 of the housing 12 with respect to each other.

A pair of cylinders 52 is provided and each of the cylinders 52 has a bottom end 54 and an outer surface 56. The bottom end 54 of each of the cylinders 52 is coupled to the upper end 48 of a respective one of the poles 42. A cross member 58 is provided which has a first end 60, a second end 62 and a bottom edge 63 extending between the first end 60 and the second end 62. Each of the first end 60 and the second end 62 is coupled to the outer surface 56 of a respective one of the cylinders 52.

A pair of actuators 64 is provided and each of the actuators 64 is positioned within the housing 12. Each of the actuators 64 is in mechanical communication with a respective one of the poles 42 and each of the actuators 64 urges the respective pole 42 into an elongated condition when the actuators 64 are actuated into a first condition. Conversely, each of the actuators 64 urges the respective pole 42 into a retracted position when the actuators 64 are actuated into a second condition. Each of the poles 42 urges the lid 28 into an open position when the poles 42 are urged into the elongated condition. Each of the actuators 64 may comprise a hydraulic pump and a piston that extends into the respective pole 42 for extending and retracting the respective pole 42.

A barrier 66 is provided and the barrier 66 is coupled between the pair of poles 42. The barrier 66 is elevated above the ground having the barrier 66 being horizontally oriented when the poles 42 are extended outwardly from the housing 12. In this way the barrier 66 can block water 67 sprayed from a sprinkler system 74 from contacting a vehicle 16 parked in the vehicle 16 parking spot. The barrier 66 is comprised of a hydrophobic material to repel the water 67 from the sprinkler system 74. The barrier 66 has an upper edge 68 and the upper edge 68 is coupled to the bottom edge 63 of the cross member 58. The barrier 66 has a width that is sufficient to extend between the pair of poles 42. Additionally, the barrier 66 may be comprised of a mesh material such that air can pass through the barrier 66.

A control circuit 70 is positioned in the housing 12 and the control circuit 70 is electrically coupled to each of the actuators 64. The control circuit 70 receives an extend input and a retract input. Each of the actuators 64 is actuated into the first condition when the control circuit 70 receives the extend input. Conversely, each of the actuators 64 is actuated into the second condition when the control circuit 70 receives the retract input. The control circuit 70 is electrically coupled to a power source 72 which may comprise an electrical system which services a sprinkler system 74. The sprinkler system 74 may be a sprinkler system in a lawn of a residence and the parking space 14 for the vehicle 16 may be a driveway or the like. Additionally, the control circuit 70 may be electrically coupled to a wind speed sensor 75 and the actuators 64 may be actuated into the second condition when the wind speed sensor 75 senses a wind speed that exceeds a predetermined wind speed to protect the barrier 66 from being damaged.

A receiver 76 is positioned within the housing 12 and the receiver 76 is electrically coupled to the control circuit 70. The receiver 76 is in wireless communication with a remote control 78. The control circuit 70 receives the extend input when the receiver 76 receives an extend command from the remote control 78. Additionally, the control circuit 70 receives the retract input when the receiver 76 receives a retract input from the remote control 78. The remote control 78 may comprise a smart phone or other similar type of electronic device which has wireless communication capabilities. The remote control 78 may additionally store control software, such as a smart phone app for example, to facilitate the actuators 64 to be controlled with the control software. Furthermore, the remote control 78 may be linked to a control device 80 of the sprinkler system 74 such that the actuators 64 are actuated into the first condition when the sprinkler system 74 is turned on. The receiver 76 may comprise a radio frequency receiver or the like and the receiver 76 may employ Bluetooth communication protocols.

In use, the barrier 66 is extended when the sprinkler system 74 turns on to protect the vehicle 16 from being sprayed by the sprinkler system 74. In this way the vehicle's 16 paint is protected from developing spots and potentially being faded by water 67 from the sprinkler system 74. The actuators 64 can be manually operated with the remote control 78 or automatically actuated, depending on the user's preference. The barrier 66 is retracted when the sprinkler system 74 turns off thereby facilitating the parking space 14 to appear as normal. Furthermore, a pair of the housings 12 may be positioned on opposite sides of the parking space 14 to protect both sides of the vehicle 16 from being sprayed by the sprinkler system 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A retractable fence assembly for protecting vehicle from water sprayed from a sprinkler system, said assembly comprising:
a housing being buried beneath ground wherein said housing is configured to be concealed from view, said housing being positioned adjacent to a parking space of a vehicle, said housing having an opening extending into an interior of said housing;
a lid being hingedly coupled to said housing for opening and closing said opening in said housing;
a pair of poles, each of said poles being movably disposed in said housing, each of said poles comprising a plurality of telescopic sections such that each of said poles has a telescopically adjustable height;
a pair of actuators, each of said actuators being positioned within said housing, each of said actuators being in mechanical communication with a respective one of said poles, each of said actuators urging said respective pole into an elongated condition when said actuators are actuated into a first condition, each of said actuators urging said respective pole into a retracted position when said actuators are actuated into a second condition; and
a barrier being coupled between said pair of poles, said barrier being elevated above the ground having said barrier being horizontally oriented when said poles are extended outwardly from said housing wherein said barrier is configured to block water sprayed from a sprinkler system from contacting a vehicle parked in the vehicle parking spot, said barrier being comprised of a hydrophobic material wherein said barrier is configured to repel the water from the sprinkler system.

2. The assembly according to claim 1, wherein said housing has a top wall, a back wall and a front wall, said opening extending through said top wall, said opening extending along a substantial length of said top wall, said front wall having a recess extending downwardly into said front wall, said recess being aligned with an intersection between said top wall and said front wall, said recess extending along a full length of said opening, said top wall being exposed with respect to the ground.

3. The assembly according to claim 2, wherein said lid has a rear edge, a front edge and a bottom surface extending between said front edge and said rear edge, said lid having a lip extending downwardly from said bottom surface, said lip being aligned with and being coextensive with said front edge, said lip being positioned in said recess in said front wall of said housing when said lid is in a closed position.

4. The assembly according to claim 2, wherein each of said poles has a lower end and an upper end, said lower end of each of said poles being positioned within said housing, each of said poles being positioned adjacent to opposite ends of said opening in said top wall of said housing with respect to each other.

5. The assembly according to claim 3, further comprising a pair of hinges, each of said hinges being coupled between said bottom surface of said lid and an interior surface of said back wall, each of said hinges biasing said lid into a closed position.

6. The assembly according to claim 4, further comprising a pair of cylinders, each of said cylinders having a bottom end and an outer surface, said bottom end of each of said cylinders being coupled to said upper end of a respective one of said poles.

7. The assembly according to claim 6, further comprising a cross member having a first end, a second end and a bottom edge extending between said first end and said second end, each of said first end and said second end being coupled to said outer surface of a respective one of said cylinders.

8. The assembly according to claim 7, wherein said barrier has an upper edge, said upper edge being coupled to said bottom edge of said cross member, said barrier having a width being sufficient to extend between said pair of poles.

9. The assembly according to claim 1, further comprising a control circuit being positioned in said housing, said control circuit being electrically coupled to each of said actuators, said control circuit receiving an extend input and a retract input, each of said actuators being actuated into said first condition when said control circuit receives said extend input, each of said actuators being actuated into said second condition when said control circuit receives said retract input, said control circuit being electrically coupled to a power source.

10. The assembly according to claim 9, further comprising a receiver being positioned within said housing, said receiver being electrically coupled to said control circuit, said receiver being in wireless communication with a remote control, said control circuit receiving said extend input when said receiver receives an extend command from the remote control, said control circuit receiving said retract input when said receiver receives a retract input from the remote control.

11. A retractable fence assembly for protecting vehicle from water sprayed from a sprinkler system, said assembly comprising:
a housing being buried beneath ground wherein said housing is configured to be concealed from view, said housing being positioned adjacent to a parking space of a vehicle, said housing having an opening extending into an interior of said housing, said housing having a top wall, a back wall and a front wall, said opening extending through said top wall, said opening extending along a substantial length of said top wall, said front wall having a recess extending downwardly into said front wall, said recess being aligned with an intersection between said top wall and said front wall, said recess extending along a full length of said opening, said top wall being exposed with respect to the ground;
a lid being hingedly coupled to said housing for opening and closing said opening in said housing, said lid having a rear edge, a front edge and a bottom surface extending between said front edge and said rear edge, said lid having a lip extending downwardly from said bottom surface, said lip being aligned with and being coextensive with said front edge, said lip being positioned in said recess in said front wall of said housing when said lid is in a closed position;
a pair of hinges, each of said hinges being coupled between said bottom surface of said lid and an interior surface of said back wall, each of said hinges biasing said lid into a closed position;
a pair of poles, each of said poles being movably disposed in said housing, each of said poles comprising a plurality of telescopic sections such that each of said poles has a telescopically adjustable height, each of said poles having a lower end and an upper end, said lower end of each of said poles being positioned within said housing, each of said poles being positioned adjacent to opposite ends of said opening in said top wall of said housing with respect to each other;
a pair of cylinders, each of said cylinders having a bottom end and an outer surface, said bottom end of each of said cylinders being coupled to said upper end of a respective one of said poles;
across member having a first end, a second end and a bottom edge extending between said first end and said second end, each of said first end and said second end being coupled to said outer surface of a respective one of said cylinders;
a pair of actuators, each of said actuators being positioned within said housing, each of said actuators being in mechanical communication with a respective one of said poles, each of said actuators urging said respective pole into an elongated condition when said actuators are actuated into a first condition, each of said actuators urging said respective pole into a retracted position when said actuators are actuated into a second condition, each of said poles urging said lid into an open position when said poles are urged into said elongated condition;
a barrier being coupled between said pair of poles, said barrier being elevated above the ground having said barrier being horizontally oriented when said poles are extended outwardly from said housing wherein said barrier is configured to block water from a sprinkler system from being sprayed on a vehicle parked in the vehicle parking spot, said barrier being comprised of a hydrophobic material wherein said barrier is configured to repel the water from the sprinkler system, said barrier having an upper edge, said upper edge being coupled to said bottom edge of said cross member, said barrier having a width being sufficient to extend between said pair of poles;
a control circuit being positioned in said housing, said control circuit being electrically coupled to each of said actuators, said control circuit receiving an extend input and a retract input, each of said actuators being actuated into said first condition when said control circuit receives said extend input, each of said actuators being actuated into said second condition when said control circuit receives said retract input, said control circuit being electrically coupled to a power source; and
a receiver being positioned within said housing, said receiver being electrically coupled to said control circuit, said receiver being in wireless communication with a remote control, said control circuit receiving said extend input when said receiver receives an extend command from the remote control, said control circuit receiving said retract input when said receiver receives a retract input from the remote control.
